(19) United States
(12) Patent Application Publication
(10) Pub. No.: US 2016/0306887 A1
(43) Pub. Date: Oct. 20, 2016

(54) METHODS, APPARATUSES AND SYSTEMS FOR LINKED AND PERSONALIZED EXTENDED SEARCH

(71) Applicant: BEIJING QIHOO TECHNOLOGY COMPANY LIMITED, Beijing (CN)

(72) Inventor: Tianhua LI, Beijing (CN)

(21) Appl. No.: 15/101,693

(22) PCT Filed: Nov. 25, 2014
(86) PCT No.: PCT/CN2014/092134

§ 371 Date: Jun. 3, 2016

(30) Foreign Application Priority Data
Dec. 3, 2013 (CN) 201310642388.0
Dec. 3, 2013 (CN) 201310642395.0

(51) Int. Cl. G06F 17/30

(52) U.S. Cl. CPC G06F 17/30867; G06F 17/30873

(57) ABSTRACT

The invention provides methods, apparatuses and systems for linked and personalized extended search, wherein the method for linked extended search comprises: a server receiving a search request sent by a user terminal, wherein the search request carries a first keyword that a user wants to search; according to the first keyword, searching to obtain a sorted result of first document data associated with the first keyword; according to the first keyword, determining a second keyword associated with the first keyword; and according to the second keyword and a sorting parameter corresponding to the sorted result of the first document data, searching to obtain a sorted result of second document data. As compared to the prior art, the effectiveness of the search result obtained by employing the method provided by the embodiment of the invention is higher.

### FIELD OF THE INVENTION

The invention relates to data processing technologies, and in particular, to a method, apparatus and system for linked extended search, and a method, apparatus and system for personalized extended search.

### BACKGROUND OF THE INVENTION

With the continuous development of network technologies, users more and more rely on search engines to acquire network data. In general, a user can send a search request to a server at a network side by a terminal, and according to a keyword carried in the search request, a search engine in the server searches out document data containing the keyword.

However, the data quality on the internet is uneven. In the prior art, only the literal degree of relevance between a keyword and document data is considered, and it does not take into account the specific content contained in the document data. Document data information ranked top with a high literal degree of relevance might only contain a keyword that a user wants to search, and the specific content contained in the document data is not taken into account. From the perspective of the user, it does not have a reference value.

It can be seen from this that the effectiveness of a search result obtained by an existing search data processing method is relatively low.

### SUMMARY OF THE INVENTION

In view of the above problems, there are provided a method, apparatus and system for linked extended search, and a method, apparatus and system for personalized extended search, which overcome the above problem or at least partly solve or mitigate the above problems.

Based on an aspect of the invention, the invention provides a method, apparatus and system for linked extended search, to improve the effectiveness of the search result.

The invention provides a method for linked extended search, comprising:

a server receiving a search request sent by a user terminal, wherein the search request carries a first keyword that a user wants to search;

according to the first keyword, searching to obtain a sorted result of first document data associated with the first keyword;

according to the first keyword, determining a second keyword associated with the first keyword; and

according to the second keyword and a sorting parameter corresponding to the sorted result of the first document data, searching to obtain a sorted result of second document data.

The invention further provides an apparatus for linked extended search located at a server side, which comprises:

a reception module configured to receive a search request sent by a user terminal, wherein the search request carries a first keyword that a user wants to search;

a first acquisition module configured to, according to the first keyword, search to obtain a sorted result of first document data associated with the first keyword;

a determination module configured to, according to the first keyword, determine a second keyword associated with the first keyword; and

a second acquisition module configured to, according to the second keyword and a sorting parameter corresponding to the sorted result of the first document data, search to obtain a sorted result of second document data.

The invention further provides a system for linked extended search, which comprises a server and a user terminal.

The server comprises an apparatus for linked extended search as described above.

The user terminal is configured to send a search request to the server, wherein the search request carries a first keyword that a user wants to search; such that the server, according to the first keyword, searches to obtain a sorted result of first document data associated with the first keyword; according to the first keyword, determines a second keyword associated with the first keyword; and according to the second keyword and a sorting parameter corresponding to the sorted result of the first document data, searches to obtain a sorted result of second document data.

The user terminal is further configured to display the sorted result of the first document data and the sorted result of the second document data sent by the server.

The technical effects of the method, apparatus and system for linked extended search lie in that, the server of the embodiments receives a search request sent by a user terminal, wherein the search request carries a first keyword that a user wants to search; according to the first keyword, searches to obtain a sorted result of first document data associated with the first keyword; according to the first keyword, determines a second keyword associated with the first keyword; and according to the second keyword and a sorting parameter corresponding to the sorted result of the first document data, searches to obtain a sorted result of second document data. Not only the degree of relevance between a first keyword that a user wants to search and the first document data is considered, but also a second keyword associated with the first keyword that the user wants to search is considered at the same time. From this, the second keyword that the user may pay attention to is speculated and the second document data associated with the second keyword which the user may pay attention to is obtained. Further, in the embodiment of the invention, according to the first keyword that the user wants to search, a sorted result of the first document data associated with the first keyword that the user wants to search can be obtained, and according to a sorting parameter identical to that of the sorted result of the first document data associated with the first keyword that the user wants to search, a sorted result of the second document data associated with the second keyword which the user may pay attention to can be further obtained. As compared to the prior art, the effectiveness of the search result obtained by employing the method provided by the embodiment of the invention is higher, and it reflects a linked extended search demand of the user.

Based on another aspect of the invention, the invention provides a method, apparatus and system for personalized extended search to improve the effectiveness of the search result.

The invention provides a method for personalized extended search, comprising:

a server receiving a search request sent by a user terminal, wherein the search request comprises a first keyword that a user wants to search;

the server determining a set of second keywords according to a historical search request record of the user terminal; and

the server searching to obtain document data according to the first keyword and the set of second keywords.

The invention further provides an apparatus for personalized extended search located at a server side, comprising:

a reception module configured to receive a search request sent by a user terminal, wherein the search request comprises a first keyword that a user wants to search;

a determination module configured to determine a set of second keywords according to a historical search request record of the user terminal; and

an acquisition module configured to search to obtain document data according to the first keyword and the set of second keywords.

The invention further provides a system for personalized extended search, which comprises a server and a user terminal.

The server comprises an apparatus for personalized extended search as described above.

The user terminal is configured to send a search request to the server, wherein the search request comprises a first keyword that a user wants to search; such that the server determines a set of second keywords according to a historical search request record of the user terminal; and searches to obtain document data according to the first keyword and the set of second keywords.

The technical effects of the method, apparatus and system for personalized extended search lie in that, when receiving a search request sent by a user terminal, the server of the embodiment acquires a first keyword comprised in the search request that a user wants to search; determines a set of second keywords according to a historical search request record sent by the user terminal; and searches to obtain document data according to the first keyword and the set of second keywords. The method not only takes into account the degree of relevance between the first keyword that the user wants to search and the document data, but also considers the set of second keywords comprising a high-frequency field occurring in the historical search request record, the second keyword reflects the preference of the user or the interest of the user (personalization), and the first keyword that the user wants to search and the set of second keywords that the user is interested in are combined to obtain a corresponding search result. As compared to the prior art, the effectiveness of the search result obtained by employing the method provided by the embodiments of the invention is higher, and it reflects a personalized search demand of the user.

According to yet another aspect of the invention, there is provided a computer program comprising a computer readable code which causes a computing device to perform the method for linked extended search, and/or the method for personalized extended search, when said computer readable code is running on the computing device.

According to still another aspect of the invention, there is provided a computer readable medium storing therein the computer program as described above.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 is a flow diagram of a method for linked extended search provided by an embodiment of the invention;

FIG. 2 is a presentation diagram of sorted results of URLs of each video website corresponding to “Mission Impossible 4” and “Mission Impossible 3”;

FIG. 3 is a presentation diagram of sorted results of URLs of each movie review website corresponding to “Mission Impossible 4” and “Mission Impossible 3”;

FIG. 4 is a structural schematic diagram of an apparatus for linked extended search provided by an embodiment of the invention;

FIG. 5 is a structural schematic diagram of a server provided by an embodiment of the invention;

FIG. 6 is a flow diagram of a method for personalized extended search provided by an embodiment of the invention;

FIG. 7 is a structural schematic diagram of an apparatus for personalized extended search provided by an embodiment of the invention;

FIG. 8 shows schematically a block diagram of a computing device for performing a method for linked extended search, and/or a method for personalized extended search according to the invention; and

FIG. 9 shows schematically a storage unit for retaining or carrying a program code implementing a method for linked extended search, and/or a method for personalized extended search according to the invention.

### DETAILED DESCRIPTION OF THE INVENTION

In the following the invention will be further described in connection with the drawings and the particular embodiments.

The server described in embodiments of the invention is a server providing a search engine function, for example, comprises a 360 search engine server; and the user terminal for example comprises a computing device such as a desktop computer or a notebook computer, etc., or comprises a mobile device such as a user mobile phone, etc.

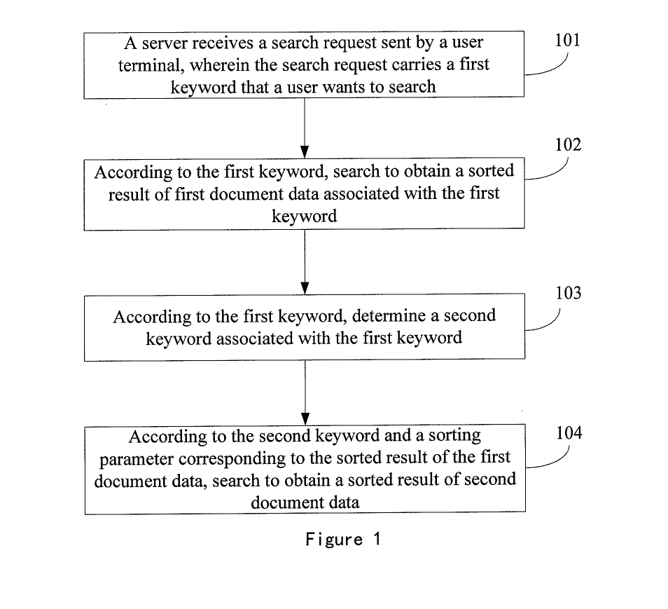

As shown in FIG. 1, FIG. 1 is a flow diagram of a method for processing search data provided by an embodiment of the invention. As shown, the method according to the embodiment comprises the following steps.

At step 101, a server receives a search request sent by a user terminal, wherein the search request carries a first keyword that a user wants to search.

In a practical application, a user enters a first keyword in an interface of a search function provided by a server by means of a user terminal, and clicks a corresponding button that triggers a search to generate a search request to be sent to the server, wherein the search request carries the first keyword that the user wants to search.

At step 102, according to the first keyword, the server searches to obtain a sorted result of first document data associated with the first keyword.

In an optional embodiment of the invention, the step 102 comprises: according to the first keyword, the server searches to obtain the first document data associated with the first keyword; and sorts the first document data according to a preset sorting parameter, to obtain a sorted result of the first document data.

For example, the server can release a lot of grabbing programs to acquire webpages on networks, and according to a webpage relevance principle, establish a correspondence relationship between each keyword and a uniform/universal resource locator (URL) of a webpage related with it, and store the correspondence relationship in a database of the server. Thus, when the user enters the first keyword (e.g., Mission Impossible 4) in a search engine, the first document data associated with the first keyword “Mission Impossible 4” (e.g., URLs of all webpages matching “Mission Impossible 4”) can be searched out in a search engine server.

After acquiring the first document data, the server can sort the searched-out first document data according to a preset sorting parameter. For example, a sorting parameter of the first document data is preset in the server. The server can directly extract the set sorting parameter of the first document data. Therein, the sorting parameter can be set specifically according to an actual application situation, for example, comprising the number of times (e.g., the click rate) that the first document data has been browsed, or the time at which the first document data was generated (for example, the time at which a movie review was generated), or the like.

At step 103, according to the first keyword, the server determines a second keyword associated with the first keyword.

The server can extend the first keyword to acquire a set of second keywords according to a preset rule, wherein the set of second keywords comprises at least one second keyword.

Therein, the preset rule for example comprises:

a field matching rule, that is, a field of the first keyword is taken as a recommended word in terms of relevance, and the set of second keywords is determined according to the recommended word, for example, the first keyword is “Mission Impossible 4”, a field “Mission Impossible” is taken as a recommended word, and the set of second keywords that can be extended to comprise “Mission Impossible 1”, “Mission Impossible 2”, and “Mission Impossible 3”; and

an association matching rule based on statistics, that is, a keyword of a similar category is searched as a recommended word according to a historical search record of the user terminal, and the set of second keywords is determined according to the recommended word, for example, the first keyword is “Mission Impossible 4”, a recommended word of a similar category is searched according to a log of network search or according to a historical search record of the user, and the set of second keywords that can be extended to comprise “the Bourne Ultimatum”, “Top Gun”, and “Knight and Day”.

It needs to be noted that, the second keyword is a keyword which is based on the first keyword and can reflect that the user might be interested in it.

At step 104, according to the second keyword and a sorting parameter corresponding to the sorted result of the first document data, the server searches to obtain a sorted result of second document data.

In an optional embodiment of the invention, the step 104 comprises:

according to the second keyword, the server searches to obtain the second document data associated with the second keyword; according to the sorted result of the first document data, acquires a sorting parameter corresponding to the sorted result of the first document data; according to the sorting parameter, sorts the second document data that is obtained by search.

For example, after the server determines a second keyword (e.g., “Mission Impossible 3”) associated with the first keyword according to the established correspondence relationship between each keyword and a URL of a webpage related with it, the second document data associated with the second keyword “Mission Impossible 3” (e.g., URLs of all webpages matching “Mission Impossible 3”) can be searched out in a search engine server; afterwards, the server can sort the searched-out second document data related with “Mission Impossible 3” according to a sorting parameter of the first document data related with “Mission Impossible 4”.

The server of the embodiment receives a search request sent by a user terminal, wherein the search request carries a first keyword that a user wants to search; according to the first keyword, searches to obtain a sorted result of first document data associated with the first keyword; according to the first keyword, determines a second keyword associated with the first keyword; and according to the second keyword and a sorting parameter corresponding to the sorted result of the first document data, searches to obtain a sorted result of second document data. Not only the degree of relevance between a first keyword that a user wants to search and the first document data is considered, but also a second keyword associated with the first keyword that the user wants to search is considered at the same time. From this, the second keyword that the user may pay attention to is speculated and the second document data associated with the second keyword which the user may pay attention to is obtained.

Further, in the embodiment of the invention, according to the first keyword that the user wants to search, a sorted result of the first document data associated with the first keyword that the user wants to search can be obtained, and according to a sorting parameter identical to that of the sorted result of the first document data associated with the first keyword that the user wants to search, a sorted result of the second document data associated with the second keyword which the user may pay attention to can be further obtained. As compared to the prior art, the effectiveness of the search result obtained by employing the method provided by the embodiment of the invention is higher, and it reflects a linked search demand of the user.

In the following, the technical solution of the invention will be further described in detail in connection with the drawings and specific embodiments.

For example, a server having a search engine function can release a network crawler, also called a web spider, to acquire webpages on the Internet, and the server performs word segmentation on the acquired webpages to form an index table with a keyword as an index; wherein the index table is used for searching for a webpage according to a keyword index, a rapid and efficient webpage search can be achieved, and in the index table are stored keywords and URLs of webpages corresponding to the keywords.

It needs to be noted that, a network crawler is a program that automatically extracts a webpage in the prior art, it downloads a webpage from a world wide web for a search engine, and is an important component of the search engine, which will not be introduced in detail here by the invention.

A structure of the index table is as shown in the following table 1:

TABLE 1

| Keyword | URL of webpage |
|---|---|
| key1 | Page1 |
| | Page2 |
| | Page2 |
| Key2 | Page3 |
| | Page3 |
| | Page4 |
| . . . | . . . |

When the user enters a first keyword “Mission Impossible 4” in an interface of a search function provided by the server by means of the user terminal, a corresponding button that triggers a search is clicked to generate a search request to be sent to the server, wherein the search request carries the first keyword “Mission Impossible 4” that the user wants to search.

According to the first keyword “Mission Impossible 4” comprised in the search request sent by the user terminal, the server queries the index table to obtain a set of URLs of webpages corresponding to the first keyword “Mission Impossible 4” (comprising URLs of each video website corresponding to “Mission Impossible 4”).

Afterwards, according to a preset sorting parameter (e.g., the number of times that “Mission Impossible 4” has been browsed in each video website), the server sorts the URLs of each video website corresponding to “Mission Impossible 4” that are obtained by searching.

Further, according to a preset rule (the field matching rule or the association matching rule based on statistics), the server extends the first keyword to acquire a set of second keywords, wherein the set of second keywords comprises at least one second keyword.

Therein, the field matching rule refers to taking a field of the first keyword as a recommended word in terms of relevance, and determining the set of second keywords according to the recommended word, for example, the first keyword is “Mission Impossible 4”, a field “Mission Impossible” is taken as a recommended word, and the set of second keywords that can be extended to comprise “Mission Impossible 1”, “Mission Impossible 2”, and “Mission Impossible 3”.

The association matching rule based on statistics refers to searching for a keyword of a similar category to be taken as a recommended word according to a historical search record of the user terminal, and determining the set of second keywords according to the recommended word. It needs to be noted that, the server can, according to the search request sent by the user terminal, acquire the identification (e.g., the IP address) of the user terminal carried in the search request, generate a historical search request record corresponding to the identification of the user terminal, and save a keyword in a search request that is sent by the user by means of the user terminal each time into the historical search request record corresponding to the identification of the user terminal.

Therein, the historical search request record is as shown in the following table 2:

TABLE 2

| Identification of user terminal | Historical search request record |
|---|---|
| Identification 1 | key1, key2, . . . |
| Identification 2 | key1, key2, . . . |
| . . . | . . . |

For example, the first keyword is “Mission Impossible 4”, “Mission Impossible 4” belongs to a movie name of a spy war category, it is judged whether the user has searched a name of an other movie of the spy war category according to a historical search record of the user terminal, and if there is a name of an other movie of the spy war category, the name of the other movie of the spy war category is taken as a recommended word, and the set of second keywords that can be extended to comprise “the Bourne Ultimatum”, “Top Gun”, and “Knight and Day”, for example.

Suppose that the server takes “Mission Impossible 3” as an associated second keyword of “Mission Impossible 4”. The server queries the index table according to “Mission Impossible 3”, to obtain a set of URLs of webpages corresponding to the second keyword “Mission Impossible 3” (comprising URLs of each video website corresponding to “Mission Impossible 3”).

Afterwards, according to the sorted result of the URLs of each video website corresponding to “Mission Impossible 4”, the server acquires a corresponding sorting parameter (e.g., the number of times that “Mission Impossible 4” has been browsed in each video website), and according to a sorting parameter identical to that of “Mission Impossible 4”, sorts the URLs of each video website corresponding to “Mission Impossible 3”.

Afterwards, the server sends the sorted result of the searched-out URLs of each video website corresponding to “Mission Impossible 4” (the sorted result of the first document data) and the sorted result of the URLs of each video website corresponding to “Mission Impossible 3” (the sorted result of the second document data) together to the user terminal. In particular, the sorted results of URLs of each video website corresponding to “Mission Impossible 4” and “Mission Impossible 3” can be displayed together at the user terminal side by a hypertext transfer protocol (HTTP) acknowledgement.

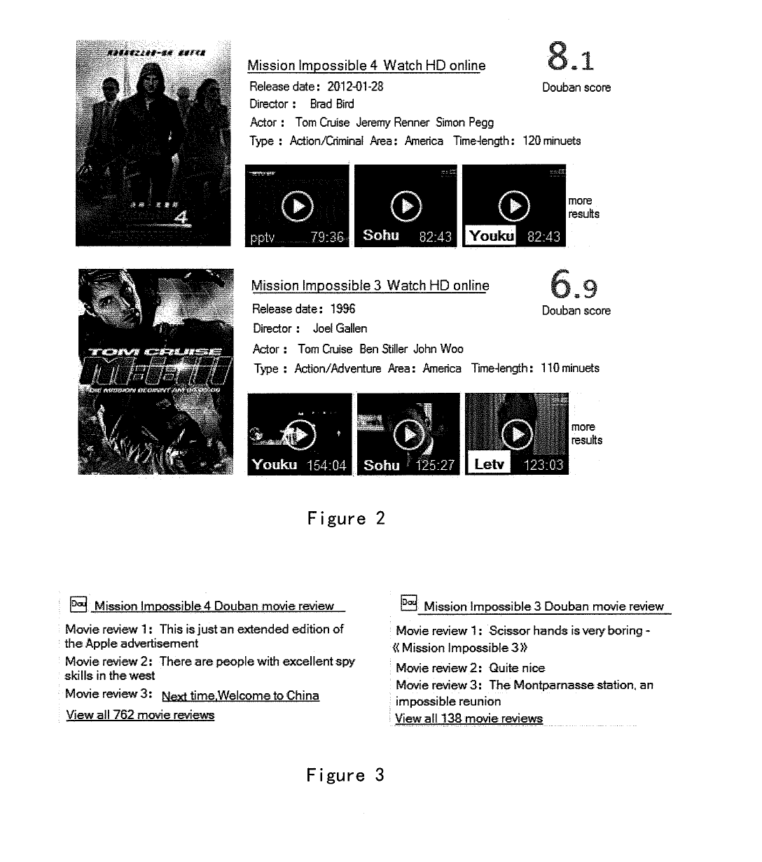

FIG. 2 is a presentation diagram of sorted results of URLs of each video website corresponding to “Mission Impossible 4” and “Mission Impossible 3”. As shown in FIG. 2, sorted results of URLs of each video website corresponding to “Mission Impossible 4” and “Mission Impossible 3” are shown together by an interface at the user terminal side, wherein the video websites of which the numbers of times that “Mission Impossible 4” has been browsed in each video website ranked top three are the PPTV video website, the Sohu video website and the Youku video website, which is a result that the user wants to search for; whereas the video websites of which the numbers of times that “Mission Impossible 3” has been browsed in each video website ranked top three are the PPTV video website, the Sohu video website and the Youku video website, which is a search result that the user may be interested in acquiring obtained by analyzing based on a result that the user wants to search for.

In this embodiment, according to a keyword entered by the user by means of the user terminal in the interface of the search function provided by the server, a result that the user wants to search for and a search result that the user may be interested in acquiring are obtained by a one-time search, and are shown together at the user terminal side, such that the user can click the URLs of the webpages (webpage links) to access a webpage that he wants to search for and a webpage that the user may be interested in, the effectiveness of the search is improved, and the degree of user experience is also high.

It needs to be noted that, when the sorting parameter of the first document data is changed, the sorted result of the second document data is also changed accordingly.

Still taking the first keyword “Mission Impossible 4” as an example for illustration, after querying the index table to obtain URLs of each movie review website related with “Mission Impossible 4”, if the sorting parameter is a movie review generation time of “Mission Impossible 4” in each movie review website, the searched-out URLs-of each movie review website related with “Mission Impossible 4” are sorted according to the movie review generation time.

Correspondingly, the URLs of each movie review website related with the second keyword “Mission Impossible 3” are also sorted according to the movie review generation time.

Afterwards, the sorted result of the searched-out URLs of each movie review website related with “Mission Impossible 4” and the sorted result of the URLs of each movie review website related with “Mission Impossible 3” are shown together at the user terminal side by an HTTP protocol acknowledgement. FIG. 3 is a presentation diagram of sorted results of URLs of each movie review website corresponding to “Mission Impossible 4” and “Mission Impossible 3”. As shown in FIG. 3, the sorted results of the URLs of each movie review website of “Mission Impossible 4” and “Mission Impossible 3” are shown together by an interface at the user terminal side.

In this embodiment, the sorted result of the second document data will change accordingly according to the change of the sorting parameter of the first document data, which reflects a linked extended search demand of the user, and improves the degree of user experience.

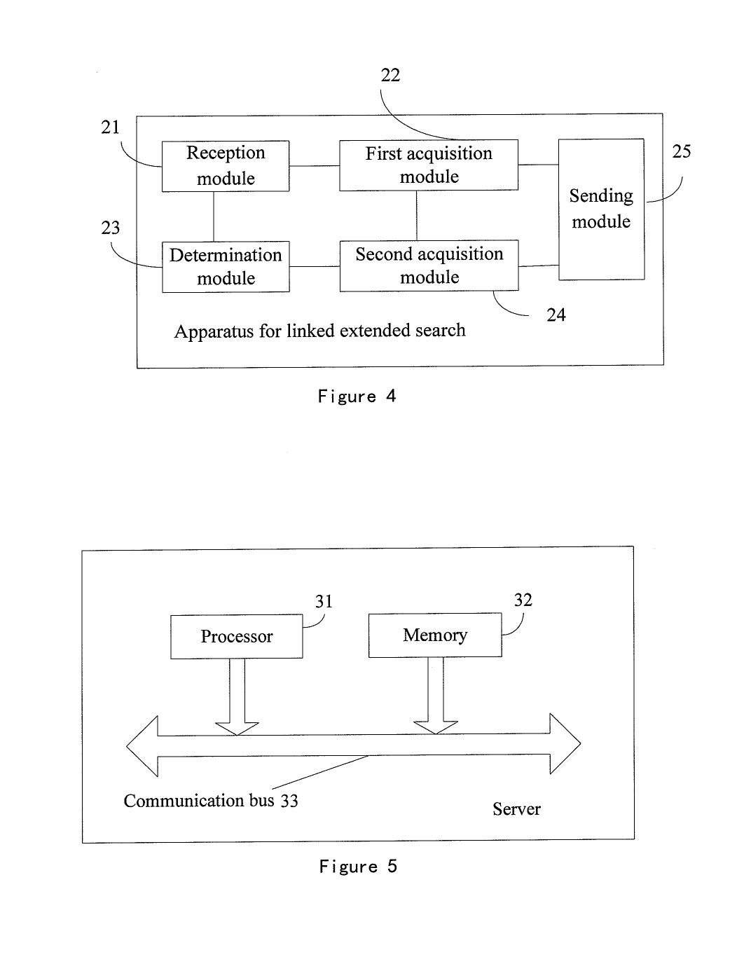

FIG. 4 is a structural schematic diagram of an apparatus for linked extended search provided by an embodiment of the invention, which, as shown in FIG. 4, can comprise:

a reception module 21 configured to receive a search request sent by a user terminal, wherein the search request carries a first keyword that a user wants to search;

a first acquisition module 22 configured to, according to the first keyword, search to obtain a sorted result of first document data associated with the first keyword;

a determination module 23 configured to, according to the first keyword, determine a second keyword associated with the first keyword; and

a second acquisition module 24 configured to, according to the second keyword and a sorting parameter corresponding to the sorted result of the first document data, search to obtain a sorted result of second document data.

Therein, the first acquisition module 22 is particularly configured to, according to the first keyword, search to obtain the first document data associated with the first keyword; and sort the first document data according to a preset sorting parameter, to obtain a sorted result of the first document data; and

the preset sorting parameter comprises the time at which the first document data was generated or the number of times that the first document data has been browsed.

Therein, the determination module 23 is particularly configured to, extend the first keyword to acquire a set of second keywords according to a preset rule, wherein the set of second keywords comprises at least one second keyword;

wherein the preset rule comprises:

a field matching rule, that is, a field in the first keyword is taken as a recommended word in terms of relevance, and the set of second keywords is determined according to the recommended word; or

an association matching rule based on statistics, that is, a keyword of a similar category is searched as a recommended word according to a historical search record of the user terminal, and the set of second keywords is determined according to the recommended word.

Therein, the second acquisition module 24 is particularly configured to,

according to the second keyword, search to obtain the second document data associated with the second keyword; according to the sorted result of the first document data, acquire a sorting parameter corresponding to the sorted result of the first document data; and according to the sorting parameter, sort the second document data that is obtained by searching.

Therein, the apparatus further comprises:

a sending module 25 configured to send the sorted result of the first document data and the sorted result of the second document data together to the user terminal for display.

The embodiment of the invention takes into account not only the degree of relevance between a first keyword that a user wants to search and the first document data, but also a second keyword associated with the first keyword that the user wants to search at the same time. From this, the second keyword that the user may pay attention to is speculated and the second document data associated with the second keyword which the user may pay attention to is obtained. Further, in the embodiment of the invention, according to the first keyword that the user wants to search, a sorted result of the first document data associated with the first keyword that the user wants to search can be obtained, and according to a sorting parameter identical to that of the sorted result of the first document data associated with the first keyword that the user wants to search, a sorted result of the second document data associated with the second keyword which the user may pay attention to can be further obtained. As compared to the prior art, the effectiveness of the search result obtained by employing the method provided by the embodiment of the invention is higher.

FIG. 5 is a structural schematic diagram of a server provided by an embodiment of the invention. As shown in FIG. 5, the server described in the embodiment comprises a processor 31, a memory 32 and a communication bus 33, wherein the processor 31 is connected with the memory 32 via the communication bus 33, in the memory 32 are saved instructions for implementing the method for processing search data, and when the processor 31 invokes the instructions in the memory 32, it can perform the following steps of:

receiving a search request sent by a user terminal, wherein the search request carries a first keyword that a user wants to search;

according to the first keyword, searching to obtain a sorted result of first document data associated with the first keyword;

according to the first keyword, determining a second keyword associated with the first keyword; and

according to the second keyword and a sorting parameter corresponding to the sorted result of the first document data, searching to obtain a sorted result of second document data.

Therein, the according to the first keyword, searching to obtain a sorted result of first document data associated with the first keyword, comprises:

according to the first keyword, searching to obtain the first document data associated with the first keyword; and

sorting the first document data according to a preset sorting parameter, to obtain a sorted result of the first document data,

wherein the preset sorting parameter comprises the time at which the first document data was generated or the number of times that the first document data has been browsed.

Therein, the according to the first keyword, determining a second keyword associated with the first keyword, comprises:

extending the first keyword to acquire a set of second keywords according to a preset rule, wherein the set of second keywords comprises at least one second keyword;

wherein the preset rule comprises:

a field matching rule, that is, a field in the first keyword is taken as a recommended word in terms of relevance, and the set of second keywords is determined according to the recommended word; or

an association matching rule based on statistics, that is, a keyword of a similar category is searched as a recommended word according to a historical search record of the user terminal, and the set of second keywords is determined according to the recommended word.

Therein, the according to the second keyword and a sorting parameter corresponding to the sorted result of the first document data, searching to obtain a sorted result of second document data, comprises:

according to the second keyword, searching to obtain the search second document data associated with the second keyword;

according to the sorted result of the first document data, acquiring a sorting parameter corresponding to the sorted result of the first document data; and

according to the sorting parameter, sorting the second document data that is obtained by searching.

Therein, there is further comprised:

sending the sorted result of the first document data and the sorted result of the second document data together to the user terminal for display.

The embodiment of the invention takes into account not only the degree of relevance between a first keyword that a user wants to search and the first document data, but also a second keyword associated with the first keyword that the user wants to search at the same time. From this, the second keyword that the user may pay attention to is speculated and the second document data associated with the second keyword which the user may pay attention to is obtained. Further, in the embodiment of the invention, according to the first keyword that the user wants to search, a sorted result of the first document data associated with the first keyword that the user wants to search can be obtained, an according to a sorting parameter identical to that of the sorted result of the first document data associated with the first keyword that the user wants to search, a sorted result of the second document data associated with the second keyword which the user may pay attention to can be further obtained. As compared to the prior art, the effectiveness of the search result obtained by employing the method provided by the embodiment of the invention is higher.

An embodiment of the invention further provides a system for linked extended search, which comprises a server and a user terminal.

The server is a server provided by the embodiment as shown in FIG. 5, and particularly comprises an apparatus for linked extended search provided by the embodiment as shown in FIG. 4, of which the detailed content will not be repeated any more.

The user terminal is configured to send a search request to the server, wherein the search request carries a first keyword that a user wants to search; such that the server, according to the first keyword, searches to obtain a sorted result of first document data associated with the first keyword; according to the first keyword, determines a second keyword associated with the first keyword; and according to the second keyword and a sorting parameter corresponding to the sorted result of the first document data, searches to obtain a sorted result of second document data.

The user terminal is further configured to display the sorted result of the first document data and the sorted result of the second document data sent by the server.

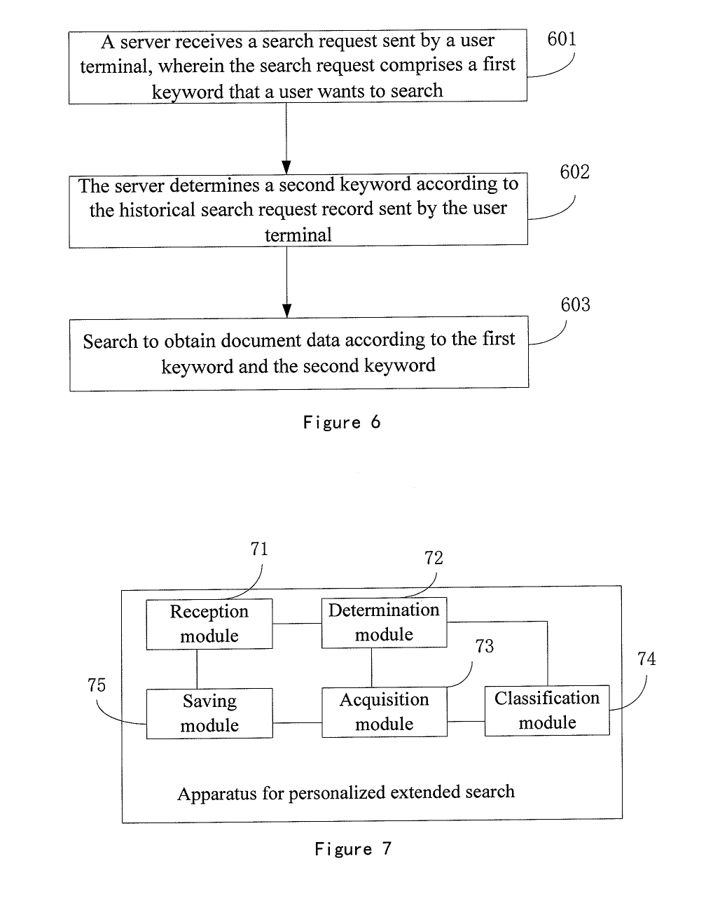

As shown in FIG. 6, an embodiment of the invention further provides a flow diagram of a method for personalized extended search. As shown, the method of this embodiment comprises the following steps.

At step 601, a server receives a search request sent by a user terminal, wherein the search request comprises a first keyword that a user wants to search.

In a practical application, a user enters a first keyword in an interface of a search function provided by a server by means of a user terminal, and clicks a corresponding button that triggers a search to generate a search request to be sent to the server, wherein the search request carries the first keyword that the user wants to search.

According to the search request sent by the user terminal, the server acquires the identification (e.g., the IP address) of the user terminal carried in the search request, generates a historical search request record corresponding to the identification of the user terminal, and saves the first keyword in the search request that is sent by the user by means of the user terminal into the historical search request record corresponding to the identification of the user terminal. Therein, the structure of the historical record of search requests is as shown in the above table 2.

At step 602, the server determines a set of second keywords according to the historical search request record of the user terminal.

For example, the server acquires the identification of the user terminal carried in the search request, determines a historical search request record corresponding to the identification of the user terminal according to the identification of the user terminal; queries the historical search request record, determines keywords of which the number of occurrences in the historical search request record of exceeds a threshold to be high-frequency words, and determines these high-frequency words to be a set of second keywords. It needs to be noted that a field of which the number of occurrences in the historical search request record exceeds a threshold generally reflects a keyword that the user is interested in or a keyword that the user prefers.

Further, after the server determines the high-frequency words according to the historical search request record corresponding to the identification of the user terminal, it can further analyze and classify the determined high-frequency words, for example, high-frequency words that users frequently search comprise “Andy Lau's film and television works”, “Han Han's works”, “plaid shirts”, “Leggings”, “warm shoes”, “Orion chips”, “Sanyuan milk”, etc., and “Andy Lau's film and television works” and “Han Han's works” can be classified as high-frequency words of an entertainment category, “plaid shirts”, “Leggings” and “warm shoes” can be classified as high-frequency words of a clothing category, and “Orion chips” and “Sanyuan milk” can be classified as high-frequency words of a food category, and afterwards, the category of the first keyword is determined in connection with the first keyword in the search request, for example, if the first keyword is “Guo Jingming's stature”, the first keyword “Guo Jingming's stature” can be classified as a keyword of the entertainment category, and thereby judge that the search that the user is currently interested in may be a search of the entertainment category, and accordingly, the high-frequency words of the same category as that of the first keyword in the historical search request record can be determined to be a set of second keywords, namely, determine “Andy Lau's film and television works” and “Han Han's works” to be a set of second keywords.

At step 603, the server searched to obtain document data according to the first keyword and the set of second keywords.

Generally, the first keyword that the user searches comprises one or more field, and a second keyword in the determined set of second keywords also comprises one ore more field; and then the step 603 may comprise:

the server combining fields comprised in the first keyword with fields comprised in the set of second keywords to determine a set of third keywords; and

searching to obtain document data respectively corresponding to each third keyword according to third keywords in the set of third keywords;

wherein the document data corresponding to a third keyword comprises a URL of a webpage corresponding to the third keyword.

In the following, the technical solution of the invention will be further described in detail in connection with the drawings and specific embodiments.

For example, the server described in the embodiment of the invention can release a network crawler, to acquire webpages on the Internet, and the server performs word segmentation on the acquired webpages to form an index table with a keyword as an index; wherein the index table is used for searching for a webpage according to a keyword index, a rapid and efficient webpage search can be achieved, and in the index table are stored keywords and URLs corresponding to the keywords. A structure of the index table is as shown in the above table 1.

After the user terminal sends a search request to the server, the server queries the index table according to a first keyword comprised in the search request sent by the user terminal, to obtain a set of URLs of webpages corresponding to the first keyword (i.e., a webpage search result); and afterwards, the server sends the webpage search result to the user terminal, in particular, the webpage search result is shown at the user terminal side by an HTTP acknowledgement. For example, when the first keyword comprised in the search request is “Guo Jingming's stature”, a set of URLs of webpages corresponding to the keyword “Guo Jingming's stature” is found in the index table, and URLs of webpages related with “Guo Jingming's stature” in the set of URLs of webpages are displayed one by one at the user terminal side, in order that the user can click the URLs of webpages (webpage links) to access related webpages.

Afterwards, the server can utilize the existing Cookies technique to save the first keyword that the user has searched into the historical search request record corresponding to the identification of the user terminal. For example, according to the search request sent by the user terminal, the server acquires the identification (e.g., the IP address) of the user terminal carried in the search request, generates a historical search request record corresponding to the identification of the user terminal, and saves a first keyword in a search request that is sent by the user by means of the user terminal into the historical search request record corresponding to the identification of the user terminal. Therein, the historical search request record is as shown in the above table 2. Therein, the Cookies technique is a technique that can enable a server to store a small amount of data in a hard disk or internal memory of a user terminal, or read data from a hard disk or internal memory of a user terminal. For example, when a user is browsing a certain website, the server can implant a very small text file in a hard disk or internal memory of the user terminal, and the text file is used for recording information such as user information, password, webpages that were browsed, keywords that were searched, time spent on a webpage, etc.

According to the acquired historical search request record related with the user terminal, keywords of which the number of occurrences in the historical search request record exceeds a threshold are determined to be high-frequency words, and these high-frequency words are determined to be second keywords to obtain a set of second keywords; or after the high-frequency words are determined according to the historical search request record, the determined high-frequency words are analyzed and classified, the category of the first keyword is determined in connection with the first keyword in the search request, and the high-frequency words of a category identical to that of the first keyword in the historical search request record are determined to be a set of second keywords.

For example, if the first keyword that the user searches for is “Guo Jingming's stature”, the first keyword “Guo Jingming's stature” can be classified as a keyword of an entertainment category, and thereby it is determined that the search that the user is currently interested in may be the search of the entertainment category, and therefore, the high-frequency words of the same category (the entertainment category) as that of the first keyword in the historical search request record can be determined to be a set of second keywords. Suppose that the high-frequency words of the entertainment category in the historical search request record comprise “Andy Lau's film and television works” and “Han Han's novels”, and then it can be determined that these high-frequency words of the entertainment category, “Andy Lau's film and television works” and “Han Han's novels”, are a set of second keywords.

Afterwards, according to the first keyword and the set of second keywords, the server determines a set of third keywords. In particular, the server combines fields comprised in the first keyword with fields comprised in the set of second keywords to obtain multiple third keywords (a set of third keywords).

For example, the first keyword is “Guo Jingming's stature”, then the first keyword comprises two fields, “Guo Jingming” and “stature”, and if the set of second keywords comprises “Andy Lau's film and television works” and “Han Han's novels”, then the set of second keywords comprises four fields, “Andy Lau”, “film and television works”, “Han Han”, and “novels”. The fields comprised in the first keyword are combined with the fields comprised in the set of second keywords, and the obtained set of third keywords comprises “Andy Lau's stature”, “Han Han's stature”, “Guo Jingming's film and television works”, and “Guo Jingming's novels”.

It needs to be noted that, when combining the fields comprised in the first keyword with the fields comprised in the set of second keywords, the server will perform an analysis and selection according to the meaning of a word after the combination. For example, when the field “stature” in the first keyword is combined with the field “novel” in a keyword, it is not consistent with the conventional logic of word formation, and “stature novel” will not be determined as a third keyword.

Afterwards, document data corresponding to each third keyword is obtained by searching respectively according to third keywords in the set of third keywords. For example, “Guo Jingming” in the first keyword and the “novel” field in the set of second keywords are utilized to obtain a third keyword “Guo Jingming's novels”; and the server queries the index table according to the third keyword “Guo Jingming's novels”, to obtain a set of URLs of webpages corresponding to the third keyword “Guo Jingming's novels” (i.e., a webpage search result about “Guo Jingming's novels”).

Afterwards, the server sends the webpage search result to the user terminal. In particular, the webpage search result is shown at the user terminal side by an HTTP acknowledgement, in order to enable the user to click the URLs of webpages (webpage links) to access webpages related with “Guo Jingming's novels”.

When receiving a search request sent by a user terminal, the server of the embodiment acquires a first keyword comprised in the search request that a user wants to search; determines a set of second keywords according to a historical search request record sent by the user terminal; and searches to obtain document data according to the first keyword and the set of second keywords. The method not only takes into account the degree of relevance between the first keyword that the user wants to search and the document data, but also considers the set of second keywords comprising a high-frequency field occurring in the historical search request record, the set of second keywords reflects the preference of the user or the interest of the user, and the first keyword that the user wants to search and the set of second keywords that the user is interested in are combined to obtain a corresponding search result. As compared to the prior art, the effectiveness of the search result obtained by employing the method provided by the embodiment of the invention is higher, and it reflects a personalized search demand of the user.

FIG. 7 is a structural schematic diagram of an apparatus for personalized extended search provided by an embodiment of the invention, which, as shown in FIG. 7, comprises:

a reception module 71 configured to receive a search request sent by a user terminal, wherein the search request comprises a first keyword that a user wants to search;

a determination module 72 configured to determine a set of second keywords according to a historical search request record of the user terminal; and

an acquisition module 73 configured to search to obtain document data according to the first keyword and the set of second keywords.

Therein, the determination module 72 is further configured to, according to the identification of the user terminal, determine a historical search request record corresponding to the identification of the user terminal;

the acquisition module 73 is further configured to query the historical search request record determined by the determination module 72, to acquire one or more high-frequency word;

the determination module 72 is further configured to determine the one or more high-frequency word acquired by the acquisition module 73 to be a second keyword, so as to obtain a set of second keywords, wherein the high-frequency word is a keyword of which the number of occurrences in the historical search request record exceeds a threshold.

Therein, the apparatus further comprises:

a classification module 74 configured to classify the one or more high-frequency word acquired by the acquisition module according to preset categories;

the determination module 72 is further configured to, based on the classification module 74 classifying the one or more high-frequency word acquired by the acquisition module 73, according to the category of the first keyword, determine a high-frequency word of the same category as that of the first keyword in the historical search request record to be the set of second keywords.

Therein, the acquisition module 73 is particularly configured to,

combine fields comprised in the first keyword with fields comprised in the set of second keywords to obtain a set of third keywords; and search to obtain document data respectively corresponding to each third keyword according to third keywords in the set of third keywords, wherein the document data corresponding to each third keyword comprises a uniform resource locator URL of a webpage corresponding to the third keyword.

Therein, the apparatus further comprises:

a saving module 75 configured to save the first keyword comprised in the search request that the user wants to search into the historical search request record corresponding to the identification of the user terminal.

When receiving a search request sent by a user terminal, the server of the embodiment acquires a first keyword comprised in the search request that a user wants to search; determines a set of second keywords according to a historical record of search requests sent by the user terminal; and searched to obtain document data according to the first keyword and the set of second keywords. The method not only takes into account the degree of relevance between the first keyword that the user wants to search and the document data, but also considers the set of second keywords comprising a high-frequency field occurring in the historical search request record, the second keyword reflects the preference of the user or the interest of the user, and the first keyword that the user wants to search and the set of second keywords that the user is interested in are combined to obtain a corresponding search result. As compared to the prior art, the effectiveness of the search result obtained by employing the method provided by the embodiment of the invention is higher, and it reflects a personalized search demand of the user.

The embodiment further provides a structural schematic diagram of a server, of which the architecture is similar to the structural schematic diagram of the server in previous embodiments. As shown in FIG. 5, the server as described in the embodiment comprises a processor 31, a memory 32 and a communication bus 33, wherein the processor 31 is connected with the memory 32 via the communication bus 33, in the memory 32 are saved instructions for implementing the method for processing search data, and when the processor 31 invokes the instructions in the memory 32, it can perform the following steps of: receiving a search request sent by a user terminal, wherein the search request carries a first keyword that a user wants to search;

determining a set of second keywords according to a historical search request record of the user terminal; and

searching to obtain document data according to the first keyword and the set of second keywords.

Therein, the determining a set of second keywords according to a historical search request record of the user terminal comprises:

acquiring the identification of the user terminal, and determining a historical search request record corresponding to the identification of the user terminal according to the identification of the user terminal;

querying the historical search request record to acquire one or more high-frequency word; and

determining the one or more high-frequency word to be a second keyword, so as to obtain a set of second keywords, wherein the high-frequency word is a keyword of which the number of occurrences in the historical search request record exceeds a threshold.

Therein, after querying the historical search request record to acquire one or more high-frequency word, there is comprised:

classifying the one or more high-frequency word acquired in the historical search request record according to preset categories; and

according to the category of the first keyword, determining a high-frequency word of the same category as that of the first keyword in the historical search request record to be the set of second keywords.

Therein, the searching to obtain document data according to the first keyword and the set of second keywords comprises:

combining fields comprised in the first keyword with fields comprised in the set of second keywords to determine a set of third keywords; and

searching to obtain document data corresponding to each third keyword respectively according to third keywords in the set of third keywords, wherein the document data comprises uniform resource locators URLs of webpages corresponding to each third keyword.

Therein, after receiving a search request sent by a user terminal, there is further comprised:

saving the first keyword comprised in the search request that the user wants to search into the historical search request record corresponding to the identification of the user terminal.

When receiving a search request sent by a user terminal, the server of the embodiment acquires a first keyword comprised in the search request that a user wants to search; determines a set of second keywords according to a historical search request record sent by the user terminal; and searches to obtain document data according to the first keyword and the set of second keywords. The method not only takes into account the degree of relevance between the first keyword that the user wants to search and the document data, but also considers the set of second keywords comprising a high-frequency field occurring in the historical search request record, the second keyword reflects the preference of the user or the interest of the user, and the first keyword that the user wants to search and the set of second keywords that the user is interested in are combined to obtain a corresponding search result. As compared to the prior art, the effectiveness of the search result obtained by employing the method provided by the embodiment of the invention is higher, and it reflects a personalized search demand of the user.

An embodiment of the invention further provides a system for personalized extended search, which comprises a server and a user terminal; wherein the server is a server provided by the embodiment as shown in FIG. 5, of which the detailed content will not be repeated any more.

The user terminal is configured to send a search request to the server, wherein the search request comprises a first keyword that a user wants to search; such that the server determines a set of second keywords according to a historical search request record of the user terminal; and searches to obtain document data according to the first keyword and the set of second keywords.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in a device or apparatus according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

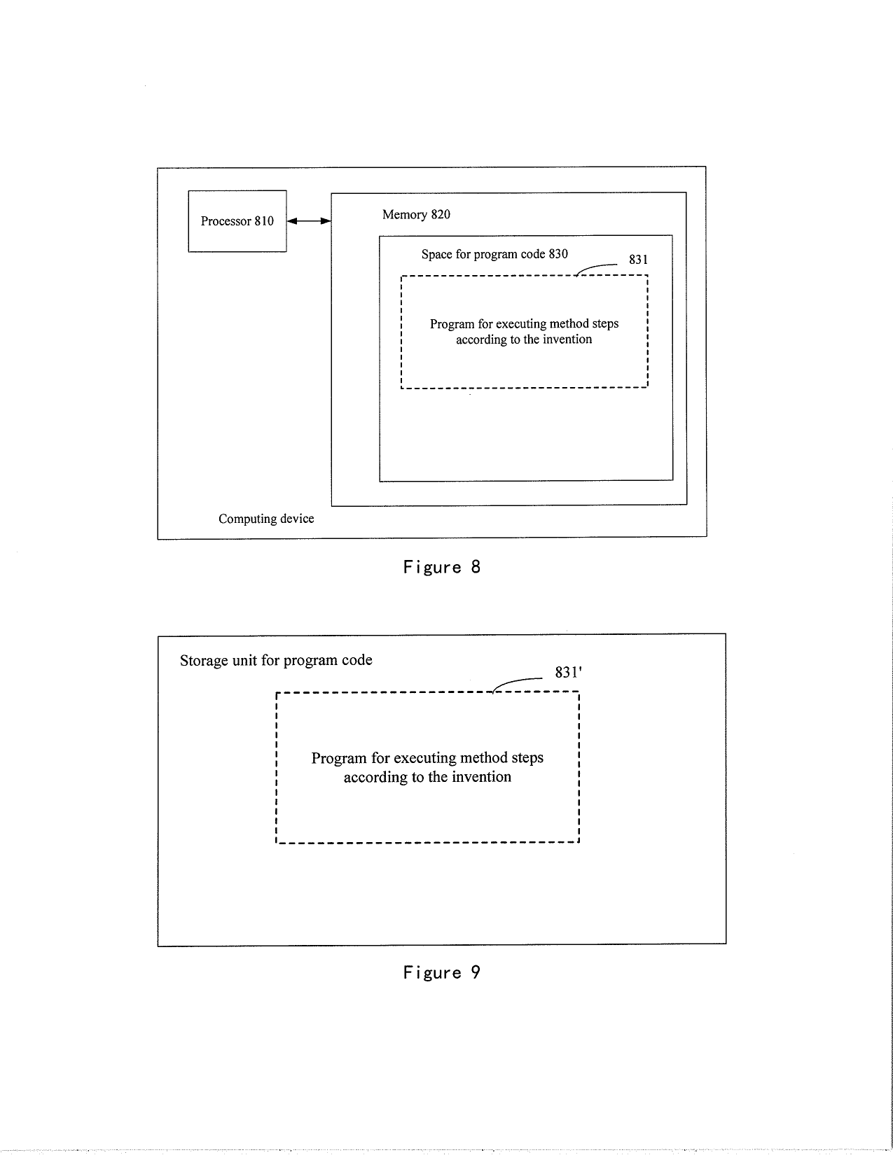

For example, FIG. 8 shows a computing device which may carry out a method for linked extended search, and/or a method for personalized extended search according to the invention. The computing device traditionally comprises a processor 810 and a computer program product or a computer readable medium in the form of a memory 820. The memory 820 may be an electronic memory such as a flash memory, an EEPROM (electrically erasable programmable read-only memory), an EPROM, a hard disk or a ROM. The memory 820 has a memory space 830 for a program code 831 for carrying out any method steps in the methods as described above. For example, the memory space 830 for a program code may comprise individual program codes 831 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 9. The storage unit may have a memory segment, a memory space, etc. arranged similarly to the memory 820 in the computing device of FIG. 8. The program code may for example be compressed in an appropriate form. In general, the storage unit comprises a computer readable code 831′, i.e., a code which may be read by e.g., a processor such as 810, and when run by a computing device, the codes cause the computing device to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” or “include” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1.-24. (canceled)

25. A method for extended search, comprising:
a server receiving a search request sent by a user terminal, wherein the search request carries a first keyword that a user wants to search;
determining a second keyword according to the first keyword; and
searching to obtain document data according to the first keyword and the second keyword.

26. The method as claimed in claim 25, wherein,
the determining a second keyword according to the first keyword comprising:
according to the first keyword, determining a second keyword associated with the first keyword;
the searching to obtain document data according to the first keyword and the second keyword comprising:
according to the first keyword, searching to obtain a sorted result of first document data associated with the first keyword; and
according to the second keyword and a sorting parameter corresponding to the sorted result of the first document data, searching to obtain a sorted result of second document data.

27. The method as claimed in claim 26, wherein the according to the first keyword, searching to obtain a sorted result of first document data associated with the first keyword, comprises:
according to the first keyword, the server searching to obtain the first document data associated with the first keyword; and
sorting the first document data according to a preset sorting parameter, to obtain a sorted result of the first document data;
wherein the preset sorting parameter comprises the time at which the first document data was generated or the number of times that the first document data has been browsed.

28. The method as claimed in claim 26, wherein the according to the first keyword, determining a second keyword associated with the first keyword, comprises:
the server extending the first keyword to acquire a set of second keywords according to a preset rule, wherein the set of second keywords comprises at least one second keyword; and
wherein the preset rule comprises:
a field matching rule, that is, a field in the first keyword is taken as a recommended word in terms of relevance, and the set of second keywords is determined according to the recommended word; or
an association matching rule based on statistics, that is, a keyword of a similar category is searched as a recommended word according to a historical search record of the user terminal, and the set of second keywords is determined according to the recommended word.

29. The method as claimed in claim 28, wherein the according to the second keyword and a sorting parameter corresponding to the sorted result of the first document data, searching to obtain a sorted result of second document data, comprises:
according to the second keyword, the server searching to obtain the second document data associated with the second keyword;
according to the sorted result of the first document data, acquiring a sorting parameter corresponding to the sorted result of the first document data; and
according to the sorting parameter, sorting the second document data that is obtained by searching;
wherein, the method further comprising:
the server sending the sorted result of the first document data and the sorted result of the second document data together to the user terminal for display.

30. The method as claimed in claim 25, wherein,
the determining a second keyword according to the first keyword comprising:
the server determining a set of second keywords according to a historical search request record of the user terminal; and
the searching to obtain document data according to the first keyword and the second keyword comprising:
the server searching to obtain document data according to the first keyword and the set of second keywords.

31. The method as claimed in claim 30, wherein the server determining a set of second keywords according to a historical search request record of the user terminal, comprises:
the server acquiring the identification of the user terminal, and determining a historical search request record corresponding to the identification of the user terminal according to the identification of the user terminal;
querying the historical search request record to acquire one or more high-frequency word, wherein the high-frequency word is a keyword of which the number of occurrences in the historical search request record exceeds a threshold; and
determining the one or more high-frequency word to be a second keyword, so as to obtain a set of second keywords.

32. The method as claimed in claim 31, wherein the determining the one or more high-frequency word to be a second keyword, so as to obtain a set of second keywords, comprises:
the server classifying the one or more high-frequency word acquired in the historical search request record according to preset categories; and
according to the category of the first keyword, determining a high-frequency word of the same category as that of the first keyword in the historical search request record to be the set of second keywords.

33. The method as claimed in claim 30, wherein the server searching to obtain document data according to the first keyword and the set of second keywords, comprises:
the server combining fields comprised in the first keyword with fields comprised in the set of second keywords to obtain a set of third keywords; and
searching to obtain document data corresponding to each third keyword respectively according to the third keywords in the set of third keywords, wherein the document data corresponding to each third keyword comprises a uniform resource locator URL of a webpage corresponding to the third keyword;
wherein, after the server receiving the search request sent by the user terminal, there is further comprised:
the server saving the first keyword comprised in the search request that the user wants to search into the historical search request record corresponding to the identification of the user terminal.

34. An apparatus for extended search, comprising:
a memory having instructions stored thereon;
a processor configured to execute the instructions to perform following operations:
receiving a search request sent by a user terminal, wherein the search request carries a first keyword that a user wants to search;
determining a second keyword according to the first keyword; and
searching to obtain document data according to the first keyword and the second keyword.

35. The apparatus as claimed in claim 34, wherein,
the determining a second keyword according to the first keyword comprising:
according to the first keyword, determining a second keyword associated with the first keyword;
the searching to obtain document data according to the first keyword and the second keyword comprising:
according to the first keyword, searching to obtain a sorted result of first document data associated with the first keyword; and
according to the second keyword and a sorting parameter corresponding to the sorted result of the first document data, searching to obtain a sorted result of second document data.

36. The apparatus as claimed in claim 35, wherein the according to the first keyword, searching to obtain a sorted result of first document data associated with the first keyword, comprises:
according to the first keyword, searching to obtain the first document data associated with the first keyword; and
sorting the first document data according to a preset sorting parameter, to obtain a sorted result of the first document data;
wherein the preset sorting parameter comprises the time at which the first document data was generated or the number of times that the first document data has been browsed.

37. The apparatus as claimed in claim 32, wherein the according to the first keyword, determining a second keyword associated with the first keyword, comprises:
extending the first keyword to acquire a set of second keywords according to a preset rule, wherein the set of second keywords comprises at least one second keyword; and
wherein the preset rule comprises:
a field matching rule, that is, a field in the first keyword is taken as a recommended word in terms of relevance, and the set of second keywords is determined according to the recommended word; or
an association matching rule based on statistics, that is, a keyword of a similar category is searched as a recommended word according to a historical search record of the user terminal, and the set of second keywords is determined according to the recommended word.

38. The apparatus as claimed in claim 37, wherein the according to the second keyword and a sorting parameter corresponding to the sorted result of the first document data, searching to obtain a sorted result of second document data, comprises:
according to the second keyword, searching to obtain the second document data associated with the second keyword;
according to the sorted result of the first document data, acquiring a sorting parameter corresponding to the sorted result of the first document data; and
according to the sorting parameter, sorting the second document data that is obtained by searching;
wherein, the operations further comprise:
sending the sorted result of the first document data and the sorted result of the second document data together to the user terminal for display.

39. The apparatus as claimed in claim 34, wherein,
the determining a second keyword according to the first keyword comprising:
determining a set of second keywords according to a historical search request record of the user terminal; and
the searching to obtain document data according to the first keyword and the second keyword comprising:
searching to obtain document data according to the first keyword and the set of second keywords.

40. The apparatus as claimed in claim 39, wherein the determining a set of second keywords according to a historical search request record of the user terminal, comprises:
acquiring the identification of the user terminal, and determining a historical search request record corresponding to the identification of the user terminal according to the identification of the user terminal;
querying the historical search request record to acquire one or more high-frequency word, wherein the high-frequency word is a keyword of which the number of occurrences in the historical search request record exceeds a threshold; and
determining the one or more high-frequency word to be a second keyword, so as to obtain a set of second keywords.

41. The apparatus as claimed in claim 40, wherein the determining the one or more high-frequency word to be a second keyword, so as to obtain a set of second keywords, comprises:
classifying the one or more high-frequency word acquired in the historical search request record according to preset categories; and
according to the category of the first keyword, determining a high-frequency word of the same category as that of the first keyword in the historical search request record to be the set of second keywords.

42. The apparatus as claimed in claim 39, wherein the searching to obtain document data according to the first keyword and the set of second keywords, comprises:
combining fields comprised in the first keyword with fields comprised in the set of second keywords to obtain a set of third keywords; and
searching to obtain document data corresponding to each third keyword respectively according to the third keywords in the set of third keywords, wherein the document data corresponding to each third keyword comprises a uniform resource locator URL of a webpage corresponding to the third keyword;
wherein, after receiving the search request sent by the user terminal, the operations further comprise:
saving the first keyword comprised in the search request that the user wants to search into the historical search request record corresponding to the identification of the user terminal.

43. A system for extended search, wherein it comprises a server and a user terminal;
the server comprises an apparatus for extended search as claimed in claim 34;
the user terminal is configured to send a search request to the server, wherein the search request carries a first keyword that a user wants to search; such that the server, according to the first keyword, determines a second keyword; and searches to obtain document data according to the first keyword and the second keyword.

44. A non-transitory computer readable medium having instructions stored thereon that, when executed by at least one processor, cause the at least one processor to perform following operations, comprising:
receiving a search request sent by a user terminal, wherein the search request carries a first keyword that a user wants to search;
determining a second keyword according to the first keyword; and
searching to obtain document data according to the first keyword and the second keyword.
